(19) United States
(12) Patent Application Publication
(10) Pub. No.: US 2008/0298669 A1
(43) Pub. Date: Dec. 4, 2008

(54) DATA PROCESSING APPARATUS AND DATA PROCESSING METHOD

(75) Inventors: Tomohiro Funakoshi, Hitachinaka (JP); Shigeaki Hijikata, Ome (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/130,527

(22) Filed: May 30, 2008

(30) Foreign Application Priority Data
May 31, 2007 (JP) 2007-145756

(51) Int. Cl. G06K 9/00

(52) U.S. Cl. 382/145

(57) ABSTRACT

A data processing apparatus according to the present invention takes in a plurality of inspection, image and attribute data output from an inspection apparatus, a review SEM image, coordinate information of hot spots found by simulation, and CAD information in the hot spots, and displays these kinds of information side by side. Tuning of inspection conditions in the inspection apparatus is facilitated from a view point of the detection rate of the hot spots. In addition, it is made possible to easily implement a fixed point observation function in a conventional review SEM by outputting coordinate data which can be read by the review SEM. Cooperation among simulation data, the inspection apparatus, and the review SEM is facilitated.

### BACKGROUND OF THE INVENTION

The present invention relates to a data processing apparatus, and data processing method. In particular, the present invention relates to a data processing apparatus, and data processing method which supports condition determining work and analysis for confirming apparatus performance in an apparatus for detecting particles and pattern defects on the surface of a semiconductor wafer, a photomask, a magnetic disk, a liquid crystal substrate or the like, and an observation apparatus for observing defects such as particles.

In the semiconductor manufacturing process, particles and pattern defects on the wafer surface cause defects in products. Therefore, it is necessary to quantify the particles and pattern defects (hereafter referred to as visual defects) and always monitor whether there is a problem in a manufacturing apparatus and a manufacturing environment. In addition, it is necessary to confirm whether a visual defect exerts a fatal influence upon products by observing the shape of the visual defect.

Conventionally, such observation work has been conducted by human visualization. This results in problems that there is a bias in positions or kinds of defects of observation subject according to the observing person and defects to be observed are not definite. Recently, an apparatus automatically makes a decision as to the size, shape and kind of a defect by using an image processing technique in order to solve the problems.

Techniques of automatic defect review (ADR) and automatic defect classification (ADC) begin to be introduced. For example, a system which efficiently conducts work while reducing the load placed on the operator when observing, i.e., reviewing a part under inspection (for example, a pattern formed on a wafer) by using an SEM (Scanning Electron Microscopy) observation apparatus is proposed (see, for example, Patent Document 1).

In recent years, defects have become fine as the working dimensions of semiconductor devices become fine. On the other hand, defects caused by the device layout (hereafter referred to as systematic defects) begin to attract attention because of decrease in the focus depth of the aligner or the process margin. As for this systematic defect, a method of executing simulation based on an optical theory by using device layout information, i.e., CAD (Computer Assisted Drawing) information, presuming where is a hot spot, and conducting verification is proposed (see, for example, Patent Document 2).

As described above, work for detecting visual defects and adhering particles (hereafter referred to as defects) is very important in improving the yield. On the other hand, inspection apparatuses are required to have ability and performance which makes it possible to detect finer defects as the semiconductor devices become finer. As a result, inspection apparatuses capable of detecting defects with high sensitivity are appearing. However, it is gradually becoming difficult to detect the above-described systematic defects with high sensitivity by using a conventional inspection apparatus.

As a result, fixed point observation using the SEM is proposed recently. A system which compares the hot spot found from simulation with design data, observes the place, compares an actual pattern image with design data, and evaluates completion of the pattern is proposed (see, for example, Patent Document 3).
Patent Document 1: JP-A-2006-269489 (US 2006/0215901)
Patent Document 2: JP-A-2006-23649 (US 2006/0008135)
Patent Document 3: JP-A-2006-351746 (US 2006/0288325)

### SUMMARY OF THE INVENTION

When running the system which compares a pattern image at an image pickup position determined from design data with a system image representing design data as described above in an actual semiconductor manufacture site, the required time is proportionate to the number of acquired images and in general enormous time is needed. Therefore, there is a demand for optimization of detection sensitivity at the hot spot found by simulation in the conventional semiconductor pattern inspection apparatus. However, there are no tools which link design data to the pattern inspection apparatus. Furthermore, even if it is attempted to execute the optimization, it takes enormous time. Therefore, it is unreasonable to run the system in the actual semiconductor manufacture site.

There is no means for optimizing the inspection condition of the semiconductor pattern inspection apparatus for the hot spot found by simulation. Thus, it is difficult to implement such running.

The present invention has been made in view of the above-described problems, and an object thereof is to provide means for comparing the hot spots found by simulation with inspection data of a semiconductor pattern inspection apparatus, and an inspection work support system having a function capable of improving the convenience in use and early displaying a clue to clearing up the cause as an apparatus for outputting coordinate data of the hot spots to a review SEM, automatically arranging SEM images and images output from various inspection apparatuses, and determining inspection conditions or analyzing the instrumental error between apparatuses.

The object can be achieved by a data processing method comprising the steps of causing a visual inspection apparatus to acquire a plurality of pieces of defect information including defect location coordinates which indicate locations of defects and defect attributes which indicate attributes of the defects obtained by inspecting an inspection subject a plurality of times; causing a pattern hot spot simulator to calculate coordinate data of the hot spots by using a pattern layout stored in a CAD server; causing the pattern hot spot simulator to output the defect location coordinates, the defect attributes, and the coordinate data of the hot spots to a review apparatus; causing the review apparatus to acquire review image information of regions including the defect location coordinates; extracting pattern layout data corresponding to regions including the hot spots on the basis of the coordinate data of the hot spots; storing the plurality of pieces of defect information, the review image information, and the pattern layout data in a data processing apparatus; causing a data processing apparatus to arrange and store each of the defect information, the review image information, and the pattern layout data so as to associate it with the defect location coordinates; and displaying the arranged and stored data on a screen.

In other words, the object can be achieved by a data processing apparatus which takes in a plurality of inspection, image and feature quantity data output from the inspection apparatus, a review SEM image, coordinate information of the hot spots found by simulation, and CAD information in the hot spots, and displays these kinds of information side by side as a result of coordinate comparison.

According to the present invention, tuning of inspection conditions in the inspection apparatus is facilitated from a view point of the detection rate of the hot spots. In addition, it is made possible to easily implement a fixed point observation function in a conventional review SEM by outputting coordinate data which can be read by the review SEM. As a result, cooperation among simulation data, the inspection apparatus, and the review SEM can be facilitated.

According to the present invention, selection of an inspection condition under which the detection rate of the hot spots is high is facilitated by arranging the CAD information and the SEM images side by side and comparing coordinates of inspection data under a plurality of inspection conditions at the same time. As a result, time required until the inspection condition in the inspection apparatus is optimized from a viewpoint of optimization of the detection rate of the hot spots can be reduced remarkably. Eventually, the yield on the line can be improved in a short period of time.

Other objects, features and advantages of the invention will become apparent from the following description of the embodiments of the invention taken in conjunction with the accompanying drawings.

### BRIEF DESCRIPTION OF THE DRAWINGS

FIG. 1 is a general configuration diagram including a data processing apparatus according to the present invention;

FIG. 2 is a system configuration diagram showing exchange of hot spot coordinate data;

FIG. 3 is a diagram showing an example of defect information exchanged between an inspection apparatus and a review apparatus;

FIG. 4 is a diagram showing an example of a hot spot coordinate information output from a pattern hot spot simulator;

FIG. 5 is a diagram showing an example of CAD cutout data;

FIG. 6 is a diagram showing an example of attributes in the inspection apparatus;

FIG. 7 is a diagram showing a screen example on the data processing apparatus;

FIG. 8 is a diagram showing an example of the number of detected hot spots according to inspection conditions; and

FIG. 9 is a diagram showing an example of a data processing flow using the data processing apparatus according to the present invention.

### DESCRIPTION OF THE EMBODIMENTS

Hereafter, an embodiment of the present invention will be described in detail with reference to the drawings.

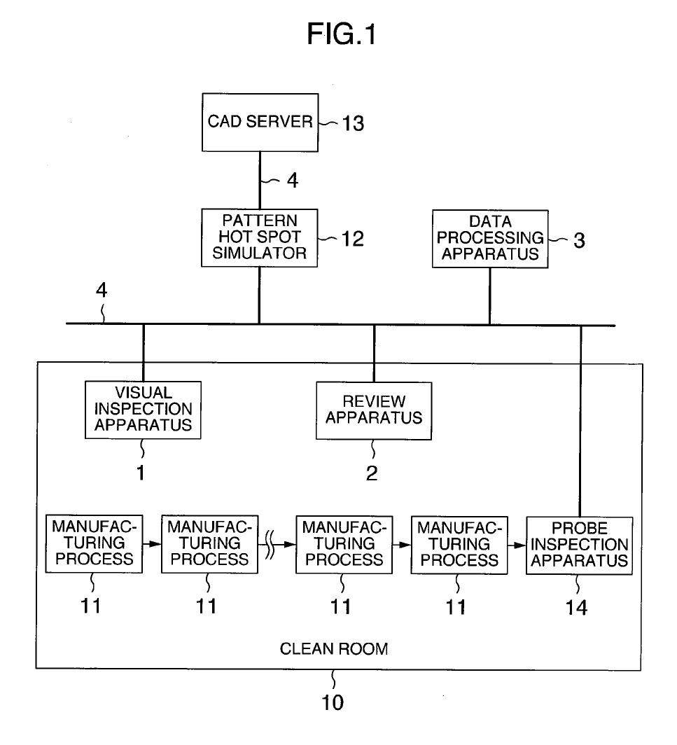

FIG. 1 is a general configuration diagram including a data processing apparatus according to the present invention. An example in which the data processing apparatus is applied to a semiconductor manufacturing line is shown. Semiconductor manufacturing processes 11 are typically executed in a clean room 10 in which a clean environment is maintained. A visual inspection apparatus 1 for detecting visual defects of product wafers, and a review apparatus 2 for observing, i.e., reviewing visual defects on the basis of data supplied from the visual inspection apparatus are installed in the clean room 10. The visual inspection apparatus 1 and the review apparatus 2 are linked to a data processing apparatus 3 for exchanging inspection and image data and a pattern hot spot simulator 12 via a communication line 4. Product wafers with a lot as the unit flow through the semiconductor manufacturing processes 11. After processing in a process previously determined to be subject to a visual inspection thereafter is finished, product wafers are carried to the visual inspection apparatus 1 by a worker or a conveyor and visual inspection processing is conducted.

Defect information 21 obtained when the visual inspection is conducted is managed in the data processing apparatus 3 by using a product name, a lot number, a wafer number, an inspection process, and inspection date and hour.

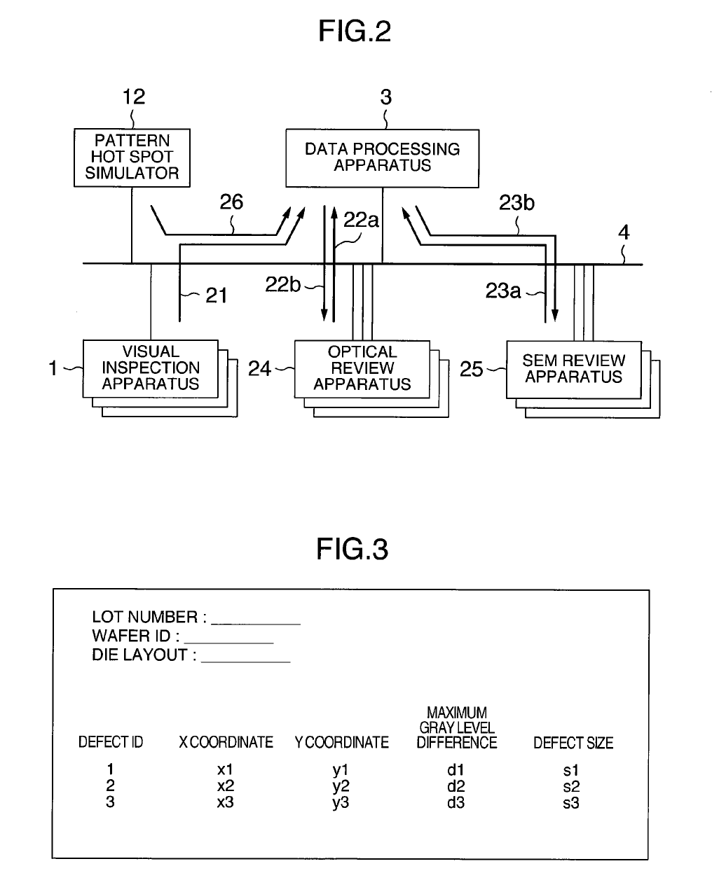

FIG. 2 is a system configuration diagram showing exchange of hot spot coordinate data. A hot spot information 26 is transmitted to the data processing apparatus 3. The hot spot information 26 is accompanied by as many CAD cutout data each depicting a semiconductor layout as shown in FIG. 5 as the number of the hot spots.

FIG. 3 is a diagram showing an example of defect information exchanged between the visual inspection apparatus 1 and the review apparatus. An example of the defect information 21 is shown. The defect information 21 contains a lot number, a wafer ID, its die layout, IDs of defects detected during the inspection, and their coordinate information. Besides, the defect information 21 contains, for example, a defect ADR image and defect attribute information (RDC information).

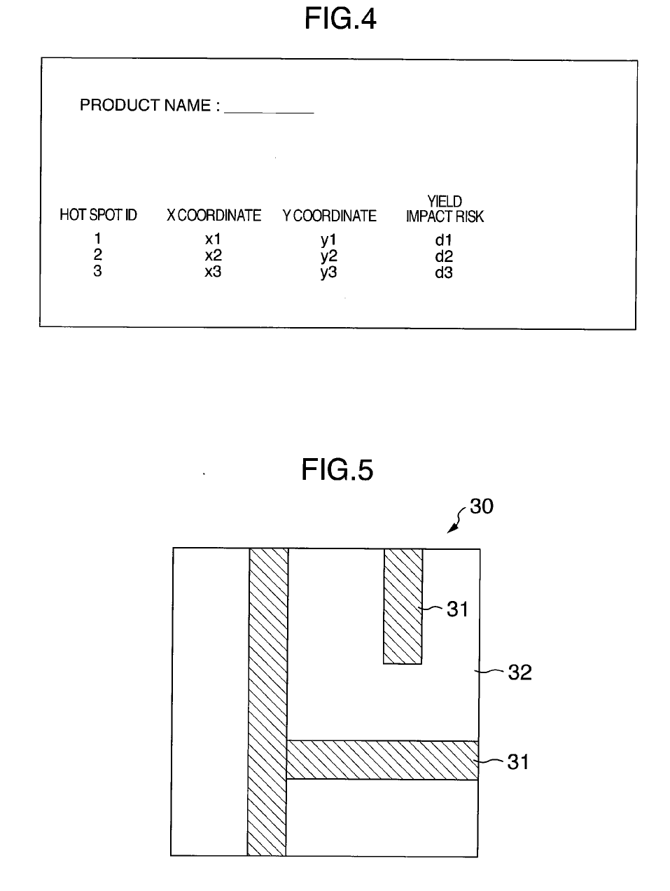

FIG. 4 shows an example of the hot spot coordinate information output from the pattern hot spot simulator 12. X and Y coordinates corresponding to a hot spot ID are indicated, and in addition an yield impact risk level is indicated.

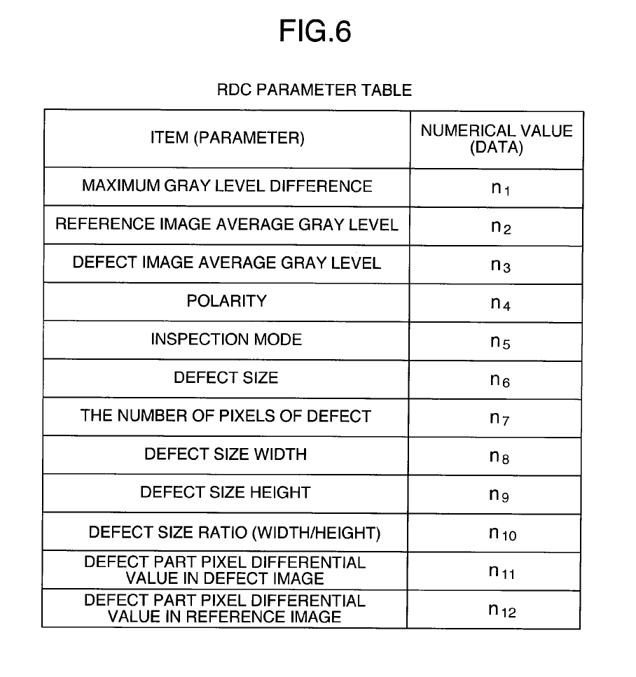

FIG. 6 shows examples of conceivable defect attribute information as an RDC parameter table. This data is transmitted together with other defect information as text data having a determined format.

As shown in FIG. 2, wafers which have finished undergoing the visual inspection are carried to the review apparatus 2 for visual defect observation, and a predetermined wafer is taken out from a lot to conduct review. When conducting review, defect information 21 is acquired from the data processing apparatus 3 by using information of a wafer to be reviewed, i.e., a lot number, a wafer number, and an inspection process as key information. This information contains not only a defect ID and coordinate data, but also an ADR image obtained at the time of inspection.

Defect information 21 output from the visual inspection apparatus 1 is enormous data. Therefore, defect information 22b or 23b extracted by the data processing apparatus 3 using a plurality of filter functions is sent to an optical review apparatus 24 or a SEM review apparatus 25 through the communication line 4. In general, the defect information 22b and 23b have the same format as that of the defect information 21.

An image of a detected defect part is acquired in the optical review apparatus 24 or the SEM review apparatus 25 on the basis of the extracted defect information 22b or 23b. Defect classification is conducted by using the image and an ADC (automatic defect classification) function mounted on each review apparatus. The information is sent to the data processing apparatus 3 through the communication line 4 as ADR/ADC information 22a or 23a.

On the other hand, a CAD server 13 shown in FIG. 1 which stores CAD layout information required for semiconductor device manufacturing transmits CAD layout information to the pattern hot spot simulator 12. Results obtained by conducting simulation to determine where a hot spot exists are stored in the pattern hot spot simulator 12. Results in the pattern hot spot simulator 12 are transmitted to the data processing apparatus 3 as the hot spot information 26 shown in FIG. 2 which is text data containing a product name, serial numbers of hot spots and coordinates.

How the inspection and defect feature quantity, image data and a hot spot information output from the visual inspection apparatus 1 are displayed and processed on the data processing apparatus 3 according to the present invention will now be described.

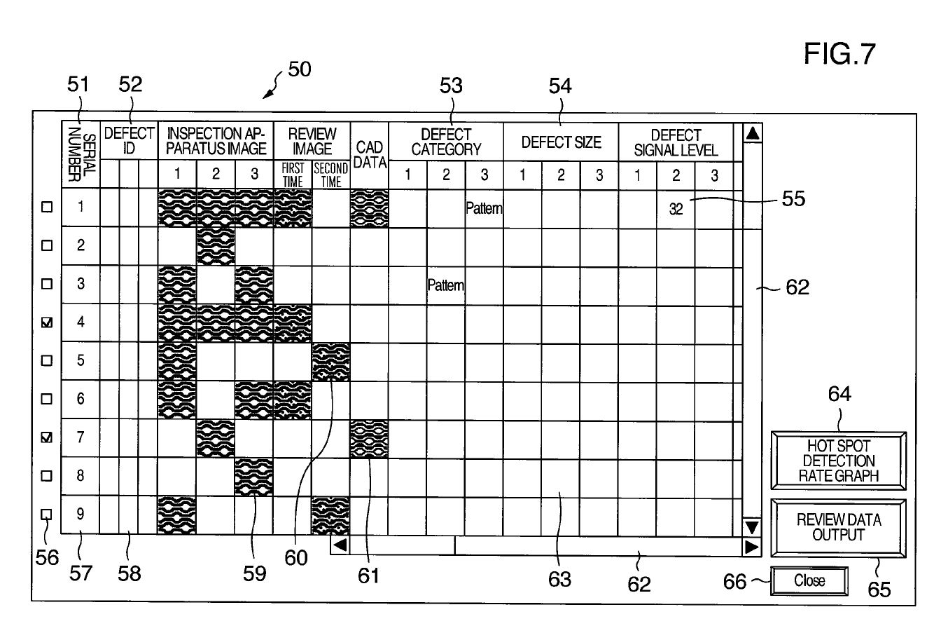

First, how the inspection and defect attribute and image data output from the visual inspection apparatus 1, the ADR/ADC information output from an observation apparatus, and the hot spot information and CAD information output from the pattern hot spot simulator 12 are displayed on the data processing apparatus 3 will now be described with reference to FIG. 7.

If an icon on a desktop of the data processing apparatus is double-clicked to start the data processing apparatus 3, a view 50 shown in FIG. 7 appears on the screen. In the view 50, a plurality of inspection/image data 59 output from the visual inspection apparatus 1, feature quantity data 55, a large amount of ADR/ADC information (60 and 53 in FIG. 7) output from the observation apparatus, and CAD cutout data 61 output from the pattern hot spot simulator 12 are displayed side by side as a result of comparing those coordinate information with each other. An arbitrary part is displayed by using a scroll bar 62. As for each vertical row, information can be displayed in an ascending order or a descending order by clicking a title part 51, 52 or the like.

Each of a plurality of inspection data displayed in the view 50 has a defect ID 52 provided in each inspection. When a result of comparison is output as a review file, it is hard to associate a defect with a defect in the view 50. In the present data processing apparatus 3, therefore, a serial number 57 is provided automatically. As a result, all information taken in the present data processing apparatus 3 is managed by using the serial number 51.

FIG. 7 is a diagram showing a screen example of the data processing apparatus 3. Here, an example in which inspection apparatus images acquired in the case where the inspection conditions are three conditions and images corresponding to twice taken in by the review SEM are displayed is shown. A number corresponding to the inspection condition and image data is displayed in the title of the screen 50.

As shown in FIG. 7, the images 59, 60 and 61 are displayed only in portions where an image exists. As for the hot spots supplied by the pattern hot spot simulator 12, the screen 50 indicates that a place where CAD cutout data 61 exists is the hot spot.

By checking a defect selection part 56 and pressing a review data output button 65, a defect contained in a review file transmitted to the review SEM can be selected arbitrarily.

As for hot spot data, there is only coordinate data corresponding to one shot supplied from the pattern hot spot simulator 12. When taken in the present data processing apparatus 3, the coordinate data corresponding to one shot is automatically developed over the whole surface of the wafer. Coordinate data corresponding to the whole surface of the wafer are stored in the present data processing apparatus 3.

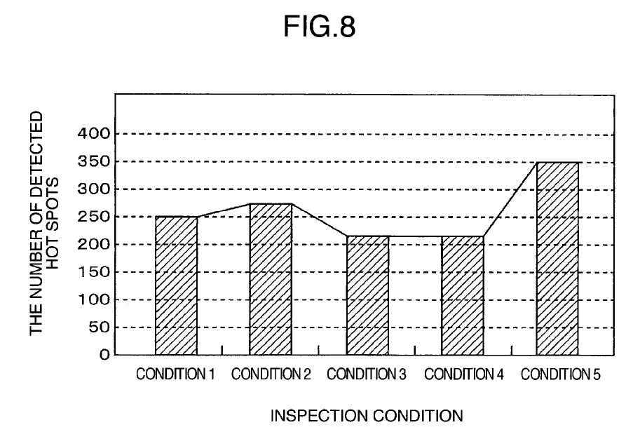

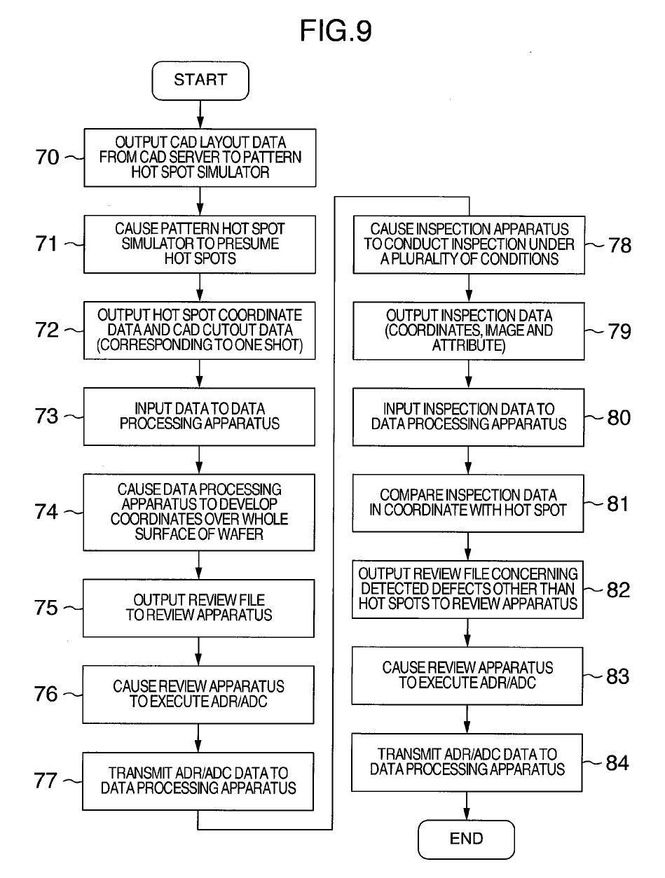

FIG. 8 is a diagram showing an example of the number of detected hot spots according to inspection conditions. For identifying an inspection condition under which, for example, the most attentive hot spots are detected after a desired work is finished, a button 64 on the screen 50 shown in FIG. 7 is pressed. As a result, a graph instantaneously indicates the number of detected hot spots under each inspection condition. For example, in this example, it can be appreciated easily that the most attentive hot spots are detected under the condition 5.

By watching the SEM image displayed in the view 50 shown in FIG. 7, it can be confirmed easily whether the hot spot has become a defect which influences the yield lowering.

FIG. 9 shows an example of data output from respective apparatuses when the present data processing apparatus 3 is used and a processing procedure on the data, in the form of a flow chart.

First, the user outputs desired CAD layout data from the CAD server 13 to the pattern hot spot simulator 12 (70 in FIG. 9). The pattern hot spot simulator 12 calculates hot spots (71). As for this data, the user himself or herself may calculate, or information supplied from an EDA (Electric Design Automation) vendor which provides calculation data on the basis of CAD data may be used.

The pattern hot spot simulator 12 outputs hot spot coordinate data described in a predetermined format (FIG. 4) (72). The hot spot coordinate data is input to the data processing apparatus 3 via the network (73). Data corresponding to only one shot is automatically developed over the whole surface of the wafer (74). For example, here, coordinate data of the hot spots may be transmitted to the review apparatus as a review file (75). As a result, a coordinate format (FIG. 3) which can be read by a YMS (Yield Management System) as well is output. Therefore, it is also possible to handle the present data in an existing data communication environment.

ADR/ADC information from a review apparatus is transmitted to the data processing apparatus 3 after reviewing (77).

Thereafter, inspection is conducted under a plurality of inspection conditions considered to include optimum conditions, in the visual inspection apparatus 1 (78). The visual inspection apparatus 1 outputs a set of inspection data (the coordinates, image and attribute) to the data processing apparatus 3 (79). The set of inspection data is input to the data processing apparatus 3 (80). Thereupon, comparison in coordinate between the set of inspection data and the hot spot information already taken in the data processing apparatus 3 is automatically conducted (81).

As occasion demands, a review file of random defects other than the hot spots already reviewed is output (82). It is also possible to execute ADR/ADC by using a review apparatus (83).

According to the present invention, a data processing apparatus takes in a plurality of inspection, image and attribute data output from the inspection apparatus, a review SEM image, coordinate information of hot spots found by simulation, and CAD information in the hot spots, and displays these kinds of information side by side as a result of coordinate comparison. Tuning of inspection conditions in the inspection apparatus is facilitated from a view point of the detection rate of the hot spots. In addition, it is made possible to easily implement a fixed point observation function in a conventional review SEM by outputting coordinate data which can be read by the review SEM. As a result, cooperation among simulation data, the inspection apparatus, and the review SEM is facilitated.

Eventually, time required until the inspection condition for detecting hot spots is optimized can be reduced remarkably.

It should be further understood by those skilled in the art that although the foregoing description has been made on embodiments of the invention, the invention is not limited thereto and various changes and modifications may be made without departing from the spirit of the invention and the scope of the appended claims.

1. A data processing method comprising the steps of:
causing a visual inspection apparatus to acquire a plurality of pieces of defect information including defect location coordinates which indicate locations of defects and defect attributes which indicate attribute of the defects obtained by inspecting an inspection subject a plurality of times;
causing a pattern hot spot simulator to calculate coordinates of hot spots by using a pattern layout stored in a CAD server;
causing the pattern hot spot simulator to output the defect location coordinates, the defect attributes, and the coordinates of the hot spots to a review apparatus;
causing the review apparatus to acquire review image information of regions including the defect location coordinates;
extracting pattern layout data corresponding to regions including the hot spots on the basis of the coordinates of the hot spots;
storing the plurality of pieces of defect information, the review image information, and the pattern layout data in a data processing apparatus;
storing each of the defect information, the review image information, and the pattern layout data so as to associate it with the defect location coordinates; and
displaying the associated and stored data on a screen.

2. The data processing method according to claim 1, further comprising the step of automatically developing the coordinates of the hot spots over the whole subject.

3. The data processing method according to claim 1, further comprising the step of causing the pattern hot spot simulator to output the defect position coordinates and the defect attributes except the coordinates of the hot spots to the review apparatus, and causing the review apparatus to acquire review image information of regions including the defect location coordinates.

4. The data processing method according to claim 1, wherein at least one of the plurality of pieces of defect information, the review image information, and the pattern layout data associated with the defect location coordinates is arranged and displayed on same line, and a list having a plurality of lines obtained by repeating the arranged display every pair of the defect location coordinates is displayed on the screen.

5. The data processing method according to claim 4, wherein each of the lines is provided with a serial number automatically.

6. The data processing method according to claim 1, wherein the inspection conducted a plurality of times is performed under different inspection conditions, respectively.

7. The data processing method according to claim 1, further comprising the step of displaying, on the screen, a diagram which makes it possible to compare and contrast the plurality of pieces of defect information detected under a plurality of different inspection conditions with the hot spots calculated by the pattern hot spot simulator and which makes it possible to select an inspection condition under which a detection rate of the hot spots is high.

8. A data processing apparatus comprising:
means for causing a visual inspection apparatus to acquire a plurality of pieces of defect information including defect location coordinates which indicate locations of defects and defect attributes which indicate attribute of the defects obtained by inspecting an inspection subject a plurality of times;
means for causing a review apparatus supplied with the defect location coordinates and the defect attributes to acquire review image information of regions including the defect location coordinates;
means for storing pattern layout data corresponding to regions including hot spots extracted on the basis of coordinates of the hot spots which are calculated by a pattern hot spot simulator by using a pattern layout stored in a CAD server;
means for storing each of the plurality of pieces of defect information, the review image information, and the pattern layout data so as to associate it with the defect location coordinates; and
means for displaying the associated and stored data on a screen.

9. The data processing apparatus according to claim 8, wherein
the displaying means arranges and displays at least one of the plurality of pieces of defect information, the review image information, and the pattern layout data associated with the defect location coordinates on same line, and generates a list view having a plurality of lines obtained by repeating the arranged display every pair of the defect location coordinates, and
the displaying means provides each of the lines with a serial number automatically.
